(19) United States
(12) Patent Application Publication
(10) Pub. No.: US 2016/0244615 A1
(43) Pub. Date: Aug. 25, 2016

(54) METAL EFFECT PIGMENTS MODIFIED WITH A SILANE LAYER CONTAINING AT LEAST TWO DIFFERENT BIFUNCTIONAL SILANES

(71) Applicant: SCHLENK METALLIC PIGMENTS GMBH, Roth-Barnsdorf (DE)

(72) Inventors: Andreas WUEHR, Nuernberg (DE); Nina LANG, Erlangen (DE)

(73) Assignee: SCHLENK METALLIC PIGMENTS GMBH, Roth-Barnsdorf (DE)

(21) Appl. No.: 15/024,583

(22) PCT Filed: Sep. 24, 2014
(86) PCT No.: PCT/EP2014/070345

§ 371 Date: Mar. 24, 2016

(30) Foreign Application Priority Data
Sep. 25, 2013 (DE) 10 2013 015 980.6

(51) Int. Cl. C09C 1/64; C09D 11/037

(52) U.S. Cl. CPC C09C 1/648; C09D 11/037

(57) ABSTRACT

The invention relates to surface-modified metal effect pigments, which are covered are with a metal oxide layer, wherein a silane layer which has at least two different bifunctional silanes is bonded to this layer. The invention is particularly suitable for metal effect pigments of aluminium, titanium, zirconium, copper, zinc, gold, silver, tin, steel and iron, in particular aluminium pigments. In addition the invention also relates to a process for the production of the surface-modified metal effect pigments and use thereof in water-based, solvent-based or radiation-curing coating compositions.

The invention relates to surface-modified metal effect pigments and a process for their production. In addition, the invention also relates to the use of the surface-modified metal effect pigments in coating compositions.

### BACKGROUND OF THE INVENTION

Pigments, in particular metal pigments, are frequently used in varnishes, paints, printing inks, powder coatings, cosmetics or plastics for colouring. Paints, varnishes, printing inks, cosmetics and powder coatings are liquid or powdered coating materials, which are applied to surfaces in order to obtain both improved optical and physical properties, such as for example corrosion protection. After application of the coating compositions these are cured by physical and/or chemical methods in order to form a continuous solid film on this surface. These physical and chemical curing methods include for example the evaporation of solvent or curing by means of electromagnetic radiation such as for example UV radiation.

As a rule, paints and varnishes comprise binders, solvents, pigments and optionally fillers. Metal effect pigments are frequently used as pigments in order to obtain products with a high optical quality rating. Metal effect pigments are characterized by a high metallic gloss and very good covering capacity. The optical effect of metal effect pigments results from the reflection of light at the parallel aligned metal platelets.

However the use of effect pigments, in particular of metal effect pigments, in varnishes, paints, printing inks, powder coatings, cosmetics or plastics frequently presents a problem. The behaviour of metal effect pigments in the varnish depends above all on their surface modification and associated compatibility with different binders. Metal effect pigments frequently exhibit satisfactory compatibility only with a specific binder or a specific group of binders.

There is therefore a requirement for modified pigments that are compatible with many different binders such as for example polyurethane-containing binders, acrylate- or methacrylate-containing binders, polyester-containing binders, alkyd resin-containing binders, urea- or melamine resin-containing binders or epoxy resin-containing binders. In addition, pigments that can also be used both in water-based and in solvent-based systems and/or that allow use in a large number of possible applications, such as coil-coating applications, UV-curing systems, PUR and acrylate varnishes, are also desirable. An improved compatibility of pigments with a large number of different binders, in comparison with pigments that can only be used with one type of binder, leads to significant costs savings for the user of such pigments.

In addition, known pigments frequently have the disadvantage that they only allow slight orientation in the varnish system, which can lead to impairment of the desired optical effect. A further problem is that agglomeration or flocculation of the pigments has to be avoided. A high flocculation tendency is mostly attributable to insufficient steric or electrostatic stabilization of the pigments.

To date, optimization of the properties of coating systems has usually taken place through the application of reagents to metal pigments, which cause floating of the pigments (“leafing”) in the printing ink or varnish. Through this so-called leafing behaviour, the particles become aligned with the surface of the varnish film, which results in an improvement of the gloss and brilliance of the print film. However, this conversely has a negative effect on adhesion and abrasion resistance as well as intermediate layer adhesion in the case of multi-layer structures.

EP 0 634 459 A2 describes for example the use of hydrophobic alkyl silanes, such as methyltriethoxysilane or hexadecyltriethoxysilane for coating pearlescent pigments. The pearlescent pigments coated with these silanes are intended to exhibit strong leafing behaviour in varnishes and cast resins, which is intended to result in increased pearl lustre because of better orientation of the pigments at the surface. A disadvantage of this coating is that the pigments, above all in the case of water-containing varnish systems, only engage in weak interactions with the surrounding binder, which has a disadvantageous influence on the mechanical properties and, consequently, frequently the optical properties of the coating.

WO 99/57204 A1 describes effect pigments for aqueous coating systems, which are coated with reactive orientation additives such as methacryl- or vinyl-functionalized silanes. In addition to the reactive orientation additives, the pigments can also additionally be coated with hydrophobic alkyl silanes, as described in EP 0 634 459 A2. The pigments described in WO 99/57204 A1 exhibit non-leafing behaviour and are meant on the one hand to be easily wetted with the binder of an aqueous paint or an aqueous varnish and, on the other hand, to form a close bond with the surrounding binder matrix. This is intended to improve the condensation water resistance as well as resistance to corrosive influences of a cured varnish based on an aqueous coating system.

The object is now to provide a pigment which has both good application-technical and good optical properties, and which also displays good compatibility with different binders. By “application-technical properties” is meant in the context of the present invention, in particular a very good abrasion resistance and good cross-linkability and wettability of the pigment. By “good optical properties” is meant a very high gloss and good covering capacity. In particular it was an object of the present invention to provide metal effect pigments which display an improved orientability in varnish systems and thus have better optical properties and display a lower flocculation tendency.

It has now surprisingly been found that metal effect pigments which are coated with two different bifunctional silanes, broaden the scope of application of these metal pigments. It has been shown that, through two different functional groups, the advantages of both functions, e.g. better wetting or lower flocculation tendency, can be exploited in a targeted manner.

### SUMMARY OF THE INVENTION

The present invention therefore relates to modified metal effect pigments, wherein the modified metal effect pigments are metal effect pigments which are covered with at least one layer of a metal oxide selected from the group consisting of silicon dioxide, aluminium oxide, titanium dioxide, iron oxide, tin oxide, zinc oxide and mixtures thereof, wherein a silane layer which comprises at least two different bifunctional silanes or units derived therefrom, is bonded to this layer, characterized in that

the at least two different bifunctional silanes are selected from a combination of
1) a primary amine-functionalized silane, and a different silane selected from the group consisting of (meth)acryl-, vinyl-, cyano-, hydroxyl-, epoxy-, isocyanate-, mercapto-functionalized silane and a secondary amine-functionalized silane
2) a (meth)acryl-functionalized silane and an isocyanate- or epoxy-functionalized silane or
3) an azide-functionalized silane and a (meth)acryl-, vinyl-, cyano-, amine-, hydroxyl-, epoxy-, isocyanate- or mercapto-functionalized silane.

The invention also relates to a process for the production of the modified metal effect pigments according to the invention according to claim 5 and use thereof in coating systems.

### DETAILED DESCRIPTION OF THE INVENTION

The invention describes modified metal effect pigments which are coated with at least two different bifunctional silanes.

The modified metal effect pigments are metal effect pigments which are covered with at least one layer of one or more metal oxides. The oxides used in the metal oxide layer comprise silicon dioxide, aluminium oxide, titanium dioxide, iron oxide, tin oxide and zinc oxide or mixtures thereof. There may however also be two or more layers of different metal oxides such as e.g. silicon dioxide and iron oxide, silicon oxide and aluminium oxide or silicon oxide and titanium dioxide. The application of the metal oxide layer is effected according to processes known to a person skilled in the art. For example the application of a silicon oxide layer can take place via a sol-gel process, in which tetraethyl orthosilicate, a short-chain alcohol, water and a base are used. The application of an iron oxide layer can take place e.g. by titration of an aqueous FeCl₃ solution, wherein the pH is kept constant by titration of an inorganic base preferably at a pH in the range of from 2.5-3.5. The application of a titanium dioxide layer can take place for example by addition of an aqueous TiCl₄ solution to an aqueous solution of the pigment at a pH preferably in the range of from 1.5-2.5. Preferably the metal oxide layer comprises no metal hydroxide or metal oxide hydrate.

A silane layer is bonded to the at least one layer of one or more metal oxides. The silane layer comprises at least two different bifunctional silanes or units derived therefrom.

It has been shown that by using two different bifunctional silanes, metal effect pigments according to the invention can be provided, which exhibit better compatibility and wetting with different binders, while retaining good optical properties and low flocculation tendency. Metal effect pigments which are modified with an amine-functionalized silane in addition to another functionalized silane, further surprisingly have particularly good gassing stability, in particular in the presence of iron oxide pigments as further pigments in addition to the metal effect pigments according to the invention.

Generally silanes with two functional groups are called bifunctional silanes.

The first functional group, which serves for anchoring the compound to the pigment surface, is a silane group of general formula (I)

—SiXₙR₃₋ₙ (I),

wherein
X is usually selected from hydroxy, halogen, such as Cl or Br, or alkoxy, such as methoxy, ethoxy, propoxy, butoxy, methoxyethoxy, butoxyethoxy or methoxyethoxyethoxy,
R is usually a C₁₋₃-alkyl, such as methyl, ethyl, propyl or isopropyl and
n is an integer between 1 and 3.

The second functional group is a group which can react chemically with the binder. The second functional group is usually linked terminally to the silane group via a branched or unbranched alkylene spacer group.

Due to the presence of the second reactive functional group, the bifunctional silanes described herein differ from non-reactive silanes such as alkyl silanes, such as for example propyl silane, butyl silane, hexyl silane, octyl silane, hexadecyl silane, or octadecyl silanes and aryl silanes, such as phenyl silane. These silanes do not usually react chemically with binders and, in addition to the non-reactive alkyl or aryl group, have only a single reactive functional group, namely a silane group of the above-described general formula (I).

The second functional group is selected from the group consisting of a (meth)acryl, vinyl, cyano, amine, hydroxyl, epoxy, carboxy, azido, isocyanate, azide or mercapto group. The term “amine group” as used herein comprises primary and secondary amine groups and combinations thereof.

Preferably, in addition to the at least two different bifunctional silanes in the silane layer, no alkyl silane is additionally present in the same layer. Preferably, in addition to the metal oxide layer and the silane layer the modified metal effect pigment has no further additional layer of one or more organic polymers, in particular no polymers from the group of the polyethers, polyacrylates, polyvinylcaprolactames, cellulose, polystyrols, polyvinylalcohols, polyvinylacetates, polysiloxanes, derivatives of the named polymers or mixtures thereof.

The silanes used are preferably low-molecular (M<500 g/mol) and, in a particularly preferred embodiment, are present in monomer form.

The silanes can form bonds with the metal oxide layer covering the metal effect pigment. The silanes are covalently bonded to the metal oxide layer on the effect pigment via the silane group, forming Si—O bonds.

In an embodiment, the at least two different bifunctional silanes are selected from a combination of
a) a primary amine-functionalized silane and
b) a different silane, selected from the group consisting of a (meth)acryl-functionalized, a vinyl-functionalized, a cyano-functionalized, a secondary amine-functionalized, a hydroxyl-functionalized, an epoxy-functionalized, an isocyanate-functionalized and a mercapto-functionalized silane.

In a further embodiment the at least two different bifunctional silanes are selected from a combination of
a) a (meth)acryl-functionalized silane and
b) an isocyanate-functionalized, a secondary amine-functionalized or an epoxy-functionalized silane.

In yet a further embodiment the at least two different bifunctional silanes are selected from a combination of
a) an azide-functionalized silane and
b) a silane selected from the group consisting of a (meth)acryl-functionalized, a vinyl-functionalized, a cyano-functionalized, a primary and/or secondary amine-functionalized, a hydroxyl-functionalized, an epoxy-functionalized, an isocyanate-functionalized and a mercapto-functionalized silane.

In a preferred embodiment the at least two different bifunctional silanes are selected from a combination of a primary amine-functionalized silane and a nitrile silane. Nitrile groups can easily be oxidized to carboxylic acid groups under the effect of heat. This makes electrostatic stabilization possible in both an acid and a basic medium. In the case of an acid pH (pH<pH 7, e.g. pH 3-6) primary amine groups are present in protonated form (R—NH₃⁺). In the case of a basic pH (pH>pH 7, e.g. pH 8-11) carboxylic acids are present in deprotonated form (COO⁻). In both the acid and in the basic medium, a charge is thereby produced at the surface, and thus an electrostatic stabilization. The flocculation tendency is therefore not dependent on the pH. In addition to a pH-independent stabilization, this combination can also result in a cross-linking with the varnish matrix through the two different functional silanes. For example, carboxylic acid groups can react with free OH groups present in polyester binders, or surface-bonded primary amine groups with free COOH-groups present in polyester binders. This is possible in different polyester binders, irrespective of the number of free OH or COOH groups present in the polyester.

In a further preferred embodiment the at least two different bifunctional silanes are selected from a combination of a primary amine-functionalized silane and a secondary amine-functionalized silane. The cross-linking in different systems is improved through the different reactivity of the two amino functions. The different properties and reactivities of the primary and secondary amines can be exploited through the combination of different amines. For example secondary amines are more basic and more nucleophilic than primary amines and therefore exhibit increased reactivity with the binder in nucleophilic S_{N}-cross-linking reactions. In addition, secondary amines are more resistant (to oxidation) in comparison with primary amines. Primary and secondary amines can also react with carboxylic acid groups present in the binder, to form amides. The amides of the primary amines bear weakly acid NH groups which are deprotonated in the basic medium, wherein the amide anions produced here-by are particularly resonance-stabilized. The amides of primary amines can thus form a salt in aqueous, basic solution, which improves water solubility. This behaviour is advantageous for aqueous varnishes. This property does not apply to amides derived from secondary amines.

In a further preferred embodiment the at least two different bifunctional silanes are selected from a combination of a primary amine-functionalized silane and an epoxy-functionalized silane. The primary amino groups can for example be cross-linked with the varnish system in polyurethane-(PU)-based systems through the formation of urethane or urea bonds. The epoxy groups can e.g. be thermally cross-linked by acid anhydride groups (e.g. maleic acid anhydride) or amine groups present in the binder.

In a further preferred embodiment the at least two different bifunctional silanes are selected from a combination of a primary or secondary amine-functionalized silane and a vinyl-functionalized silane. While the amines can react, amongst other things, with free isocyanate units of a 2K/1K-PU system, through the vinyl silane, additional possible cross-linking reactions with a binder with conjugated double-bonds take place via a cycloaddition. A reaction is for example possible via a Diels-Alder reaction. With binders with isolated double-bonds, cross-linking is possible via the so-called “ene” reaction.

In yet a further preferred embodiment, the at least two different bifunctional silanes are selected from a combination of a primary or secondary amine-functionalized silane and a (meth)acryl-functionalized silane. This combination can generate good adhesion properties in both a PU and in a UV varnish system. The methacryl function can react in a radical polymerization with a UV binder, such as e.g. an acrylate-containing binder, while amines can react, amongst other things, with free isocyanate units of a 2K/1K-PU system.

In yet a further preferred embodiment, the at least two different bifunctional silanes are selected from a combination of a (meth)acryl-functionalized silane and an isocyanate-functionalized silane. The methacryl function can react in a radical polymerization with a UV binder, while the isocyanate group can react with alcohol or amino groups of a binder.

In yet a further preferred embodiment, the at least two different bifunctional silanes are selected from a combination of an azide-functionalized silane and a (meth)acryl-, vinyl-, cyano-, amine-, hydroxyl-, epoxy-, isocyanate- or mercapto-functionalized silane.

Examples of amine-functionalized silanes are 3-aminopropyltriethoxysilane, 3-aminopropyltrimethoxysilane, 4-aminobutyltriethoxysilane, 3-aminopropyltris(methoxyethoxyethoxy)silane, 11-aminoundecyltriethoxysilane, 3-aminopropyl silanetriol, 3-aminopropylmethyldiethoxysilane, 3-aminopropyldiisopropylethoxysilane, 3-aminopropyldimethylethoxysilane, N-aminoethyl-aminopropyltrimethoxysilane, N-aminoethyl-3-aminopropyltriethoxysilane, N-aminohexyl-2-aminomethyltriethoxysilane, N-aminohexyl-aminomethyltrimethoxysilane, N-aminoethyl-11-aminoundecyltrimethoxysilane, (aminomethylaminomethyl)phenethyltrimethoxysilane, N-aminoethyl-3-aminopropyl silanetriol, N-aminoethyl-3-aminopropylmethyldimethoxysilane, N-aminoethyl-aminoisobutylmethyldimethoxysilane, (aminoethylamino)isobutyldimethylmethoxysilane, (trimethoxysilylpropyl)diethylene triamine, N-methyl-3-aminopropyltrimethoxysilane, N-ethylaminoisobutyltrimethoxysilane, N-(n-butyl)-3-aminopropyltrimethoxysilane, N-(n-butyl)-3-aminopropyltriethoxysilane, N-(n-propyl)-3-aminopropyltriethoxysilane, N-(n-propyl)-3-aminopropyltrimethoxysilane, N-phenyl-3-aminopropyltrimethoxysilane, N-allyl-3-aminopropyltrimetoxysilane, N-ethylaminoisobutylmethyldiethoxysilane and N-methyl-3-aminopropylmethyldimethoxysilane.

Preferred silanes functionalized with a primary amine are 3-aminopropyltriethoxysilane, 3-aminopropyltrimethoxysilane, 4-aminobutyltriethoxysilane, 11-aminoundecyltriethoxysilane, 3-aminopropylmethyldiethoxysilane and 3-3-aminopropyldimethylethoxysilane, in particular 3-aminopropyltriethoxysilane and 3-aminopropyltrimethoxysilane.

Preferred silanes functionalized with a secondary amine are N-(n-butyl)-3-aminopropyltrimethoxysilane, N-(n-butyl)-3-aminopropyltriethoxysilane, N-(n-propyl)-3-aminopropyltriethoxysilane N-(n-propyl)-3-aminopropyltrimethoxysilane, N-phenyl-3-aminopropyltrimethoxysilane, in particular N-(n-butyl)-3-aminopropyltrimethoxysilane and N-(n-butyl)-3-aminopropyltriethoxysilane.

Preferred (meth)acryl-functionalized silanes are 3-methacryloxypropyltrimethoxysilane, 3-methacryloxypropyltriethoxysilane, 2-methacryloxyethyltrimethoxysilane, 2-methacryloxyethyltriethoxysilane, 3-methacryloxypropyltris(methoxyethoxy)silane, 3-meth-acryloxypropyltris(butoxyethoxy)silane, 3-methacryloxypropyltris(propoxy)-silane, 3-methacryloxypropyltris(butoxy)silane, 3-acryloxypropyltrimethoxysilane, 2-acryloxyethyltrimethoxysilane, 3-acryl-oxypropyltrimethoxysilane, 2-acryloxy-ethyltriethoxysilane, 3-acryloxypropyltris(methoxy-ethoxy)silane, 3-acryloxypropyltris(butoxyethoxy)silane, 3-acryloxypropyl-tris(propoxy)silane and 3-acryloxypropyltris(butoxy)silane, in particular 3-methacryloxypropyltrimethoxysilane and 3-methacryloxypropyltriethoxysilane.

Preferred vinyl-functionalized silanes are vinyltrimethoxysilane, vinyltriethoxysilane, vinylethyldichlorosilane, vinylmethyldiacetoxysilane, vinylmethyldichlorosilane, vinyl-methyldiethoxysilane, vinyltriacetoxysilane and vinyl trichlorosilane, in particular vinyltriethoxysilane and vinyltrimethoxysilane.

Preferred cyano-functionalized silanes are 3-cyanopropyltriethoxysilane, 3-cyanopropyltrimethoxysilane and 2-cyanoethyltrimethoxysilane.

Preferred isocyanate-functionalized silanes are 3-isocyanatopropyltriethoxysilane and 3-isocyanatopropyltrimethoxysilane.

Preferred mercapto-functionalized silanes are 3-mercaptopyltriethoxysilane, 3-octanoylthio-1-propyltriethoxysilane and 3-mercaptopropyltrimethoxysilane.

Preferred epoxy-functionalized silanes are 3-glycidyloxypropyltrimethoxysilane, beta-(3,4-epoxycyclohexyl)ethyltrimethoxy-silane and 1,2-epoxy-4(ethyltriethoxysilyl)-cyclohexane.

Preferred azide-functionalized silanes are 6-azidosulphonylhexyltriethoxysilane and (azidomethyl)phenethyltrimethoxysilane.

In a particularly preferred embodiment, the at least two different bifunctional silanes are selected from a combination of:
1) 3-aminopropyltriethoxysilane and 3-glycidyloxypropyltrimethoxysilane,
2) 3-aminopropyltrimethoxysilane and 3-glycidyloxypropyltrimethoxysilane,
3) 4-aminobutyltriethoxysilane and 1,2-epoxy-4(ethyltriethoxysilyl)-cyclohexane,
4) 3-aminopropyltriethoxysilane and N-(n-butyl)-3-aminopropyltriethoxysilane,
5) 3-aminopropyltrimethoxysilane and N-(n-butyl)-3-aminopropyltriethoxysilane,
6) 3-aminopropyltriethoxysilane and N-(n-butyl)-3-aminopropyltrimethoxysilane,
7) 3-aminopropyltrimethoxysilane and N-(n-butyl)-3-aminopropyltrimethoxysilane,
8) 4-aminobutyltriethoxysilane and N-(n-butyl)-3-aminopropyltriethoxysilane,
9) 3-aminopropyltriethoxysilane and N-(n-propyl)-3-aminopropyltriethoxysilane,
10) 3-aminopropyltriethoxysilane and 3-methacryloxypropyltriethoxysilane,
11) 3-aminopropyltrimethoxysilane and 3-methacryloxypropyltrimethoxysilane,
12) 3-aminopropyltriethoxysilane and 3-methacryloxypropyltrimethoxysilane,
13) N-(n-butyl)-3-aminopropyltriethoxysilane and 3-methacryloxypropyltrimethoxysilane,
14) N-(n-propyl)-3-aminopropyltriethoxysilane and 3-methacryloxypropyltrimethoxysilane,
15) 3-aminopropyltriethoxysilane and vinyltriethoxysilane,
16) 4-aminobutyltriethoxysilane and vinyltriethoxysilane,
17) N-(n-butyl)-3-aminopropyltriethoxysilane and vinyltriethoxysilane,
18) 3-aminopropyltriethoxysilane and 3-isocyanatopropyltriethoxysilane,
19) 3-aminopropyltrimethoxysilane and 3-isocyanatopropyltrimethoxysilane,
20) 4-aminobutyltriethoxysilane and 3-isocyanatopropyltriethoxysilane
21) N-(n-butyl)-3-aminopropyltriethoxysilane and 3-isocyanatopropyltriethoxysilane,
22) 3-methacryloxypropyltriethoxysilane and 3-isocyanatopropyltriethoxysilane,
23) 3-methacryloxypropyltrimethoxysilane and 3-isocyanatopropyltrimethoxysilane,
24) 6-azidosulphonylhexyltriethoxysilane and 3-aminopropyltriethoxysilane,
25) 6-azidosulphonylhexyltriethoxysilane and 3-methacryloxypropyltrimethoxysilane,
26) 6-azidosulphonylhexyltriethoxysilane and 3-glycidyloxypropyltrimethoxysilane and
27) 6-azidosulphonylhexyltriethoxysilane and 3-isocyanatopropyltriethoxysilane.

Quite particularly preferred are the at least two different bifunctional silanes selected from a combination of:
3-aminopropyltriethoxysilane and 3-glycidyloxypropyltrimethoxysilane,
4-aminobutyltriethoxysilane and 1,2-epoxy-4(ethyltriethoxysilyl)-cyclohexane,
3-aminopropyltriethoxysilane and N-(n-butyl)-3-aminopropyltriethoxysilane,
3-aminopropyltrimethoxysilane and N-(n-butyl)-3-aminopropyltriethoxysilane,
3-aminopropyltriethoxysilane and N-(n-butyl)-3-aminopropyltrimethoxysilane,
3-aminopropyltriethoxysilane and 3-methacryloxypropyltrimethoxysilane,
3-aminopropyltriethoxysilane and vinyltriethoxysilane,
3-aminopropyltriethoxysilane and 3-isocyanatopropyltriethoxysilane,
3-methacryloxypropyltriethoxysilane and 3-isocyanatopropyltriethoxysilane,
3-methacryloxypropyltrimethoxysilane and 3-isocyanatopropyltrimethoxysilane, or
6-azidosulphonylhexyltriethoxysilane and 3-aminopropyltriethoxysilane,
   even more preferred
3-aminopropyltriethoxysilane and N-(n-butyl)-3-aminopropyltriethoxysilane,
3-aminopropyltriethoxysilane and N-(n-butyl)-3-aminopropyltrimethoxysilane,
6-azidosulphonylhexyltriethoxysilane and 3-aminopropyltriethoxysilane,
4-aminobutyltriethoxysilane and 1,2-epoxy-4(ethyltriethoxysilyl)-cyclohexane,
3-methacryloxypropyltriethoxysilane and 3-isocyanatopropyltriethoxysilane, or
3-methacryloxypropyltrimethoxysilane and 3-isocyanatopropyltrimethoxysilane.

The metal effect pigments can be usual metal effect pigments known to a person skilled in the art. The metal effect pigments selected from the group consisting of aluminium, titanium, zirconium, copper, zinc, gold, silver, tin, steel and iron pigments, and mixtures thereof are preferred. Furthermore, pigments of alloys of the named metals such as gold bronze can also be used. The metal effect pigments, as already made clear by the name, comprise no pearlescent pigments or mica. Aluminium pigments, in particular cornflake or silver dollar pigments are preferred. Particularly preferably, vacuum metallized pigments (VMPs) can also be used, such as for example DECOMET® particles, available from Schlenk Metallic Pigments GmbH, Roth, Germany.

In a particularly preferred embodiment the metal effect pigment is an aluminium pigment, that is covered with a layer of silicon dioxide.

Quite particularly preferred is an aluminium pigment, that is covered with a layer of silicon dioxide, wherein a silane layer which comprises at least two different bifunctional silanes or units derived therefrom is bonded to the silicon dioxide layer, characterized in that the at least two different bifunctional silanes are selected from a combination of
3-aminopropyltriethoxysilane and 3-glycidyloxypropyltrimethoxysilane,
4-aminobutyltriethoxysilane and 1,2-epoxy-4(ethyltriethoxysilyl)-cyclohexane,
3-aminopropyltriethoxysilane and N-(n-butyl)-3-aminopropyltriethoxysilane,
3-aminopropyltrimethoxysilane and N-(n-butyl)-3-aminopropyltriethoxysilane,
3-aminopropyltriethoxysilane and N-(n-butyl)-3-aminopropyltrimethoxysilane,
3-aminopropyltriethoxysilane and 3-methacryloxypropyltrimethoxysilane,
3-aminopropyltriethoxysilane and vinyltriethoxysilane,
3-aminopropyltriethoxysilane and 3-isocyanatopropyltriethoxysilane,
3-methacryloxypropyltriethoxysilane and 3-isocyanatopropyltriethoxysilane,
3-methacryloxypropyltrimethoxysilane and 3-isocyanatopropyltrimethoxysilane, or
6-azidosulphonylhexyltriethoxysilane and 3-aminopropyltriethoxysilane,
   even more preferred
3-aminopropyltriethoxysilane and N-(n-butyl)-3-aminopropyltriethoxysilane,
3-aminopropyltriethoxysilane and N-(n-butyl)-3-aminopropyltrimethoxysilane,
6-azidosulphonylhexyltriethoxysilane and 3-aminopropyltriethoxysilane,
4-aminobutyltriethoxysilane and 1,2-epoxy
4(ethyltriethoxysilyl)-cyclohexane,
3-methacryloxypropyltriethoxysilane and 3-isocyanatopropyltriethoxysilane, or
3-methacryloxypropyltrimethoxysilane and 3-isocyanatopropyltrimethoxysilane.

For the production of metal effect pigment pastes containing modified metal effect pigments, the metal effect pigment that is covered with at least one layer of a metal oxide, selected from the group consisting of silicon dioxide, aluminium oxide, titanium dioxide, iron oxide, tin oxide, zinc oxide and mixtures thereof, is suspended in an organic solvent, for example methanol, ethanol or isopropanol, preferably ethanol or isopropanol or a mixture of an organic solvent and water, for example isopropanol and water or ethanol and water.

If a mixture of an organic solvent and water is used, the mixture preferably contains 30 to 90 percent by volume organic solvent and 70 to 10 percent by volume water, more preferably 50 to 80 percent by volume organic solvent and 50 to 20 percent by volume water.

The suspension is effected accompanied by stirring and heating at a temperature in the range of from 20° C. to 80° C., preferably in the range of from 25° C. to 60° C., in particular at approximately 60° C.

At least two different bifunctional silanes (as defined above) are then added to the mixture. The addition of the at least two different bifunctional silanes can be carried out either simultaneously or successively. If the addition of the two silanes is carried out successively, the addition can take place in any order. For example, in the case of the combination of a primary amine-functionalized silane and a nitrile silane, the amine silane and then the nitrile silane can be added, or vice versa.

The two different bifunctional silanes can be added to the mixture in each case independently of each other, in a quantity of 0.01 to 10 wt.-%, relative to the total weight of metal effect pigment with metal oxide layer. The silanes are preferably added, in each case independently of each other, in a quantity in the range of from 0.05 to 5 wt.-%, particularly preferably in a quantity in the range of from 0.1 to 1.5 wt.-%, even more preferably in a quantity in the range of from 0.3 to 1.0 wt.-% relative to the total weight of metal effect pigment with metal oxide layer.

Between the end of the addition of the first silane and the beginning of the addition of the second silane there is usually a period of less than one hour, preferably less than 30 minutes, particularly preferably less than 10 minutes.

In a preferred embodiment, a basic or acid pH is then set. The pH is preferably set to a basic pH in the range of from 8 to 12, preferably 8.5 to 11. This is usually carried out by the addition of a base, such as for example an amine such as triethylamine or ethylene diamine or ammonia and optionally water. Alternatively, the addition of the base can also be carried out at the same time as the addition of the bifunctional silanes.

The mixture is then stirred for a period of from 10 minutes to 20 hours at a temperature in a range of from 20° C. to 80° C. The stirring of the mixture is preferably effected over a period of from 30 minutes to 3 hours, preferably for approximately 1 hour at a temperature in the range of from 25° C. to 60° C., preferably at approximately 60° C.

After cooling to room temperature, preferably 20° C., the mixture can be set to the desired solids content with a suitable solvent, for example isopropanol. The mixture can also be concentrated after the reaction has ended, and the filter pigment cake obtained can either be re-dispersed in a suitable solvent, or the solvent removed. Preferably, a re-dispersal is effected, for example in isopropanol.

The solids content of the modified metal effect pigment paste can lie within the range of from 1 to 80 wt.-%, preferably in the range of from 50 to 70 wt.-%.

The modified metal effect pigments and metal effect pigment pastes described above are suitable for use in coating compositions, in particular in the production of varnishes, paints, printing inks, cosmetics such as e.g. nail varnish, or plastics.

After processing, these have excellent application-technical and also optical properties, in particular with a very good abrasion resistance and condensation water resistance in combination with very good metallic gloss effects.

The use according to the invention covers in particular offset-printing inks, screen printing inks (also in-mould technology), flexographic inks, overprint varnishes, gravure inks, inkjet inks, digital printing inks (such as inkjet), aqueous varnish systems or cosmetics such as nail varnishes. The uses according to the invention are also particularly suitable for the coating of plastics, wooden parts, metal parts, glass parts, as coil & can coating, and for the coating of 3D components via dual-cure curing with 2K PU-systems.

The incorporation and mixing of the modified pigments according to the invention into the coating systems is effected in the usual way, familiar to a person skilled in the art. In particular stirring units with propeller or blade stirrers are suitable for the dispersal and homogeneous mixing of the pigments in the coating system. The modified metal effect pigments can be added to an essentially finished mixture that already contains all the additives, or to an intermediate product into which the modified metal effect pigments and then the additives are mixed.

The metal effect pigments and pastes according to the invention surprisingly exhibit improved compatibility with a large number of different binders. The scope of application of metal effect pigments is thus broadened. Through the selection of suitable combinations of bifunctional silanes for modifying the pigments, these can be used in both water-based and also in solvent-based systems. In addition, use in coil-coating applications, UV-curing systems, thermally or chemically cross-linkable systems, such as polyester, polyurethane or acrylate varnishes, is possible.

Usual, solvent-containing UV hybrid systems or aqueous UV hybrid systems and 100% solvent-free coating systems known to a person skilled in the art can be used as UV-curable coating compositions. Such coating systems usually contain binders (in particular prepolymers), solvents, water, reactive polymerizable monomers (reactive diluents), and photoinitiators, or only monomers, prepolymers (binders) and photoinitiators.

Usual, solvent-containing or aqueous varnish systems and 100% solvent-free coating systems known to a person skilled in the art can be used as thermally and/or chemically cross-linkable coating compositions. Such coating systems usually contain binders (in particular prepolymers), solvents, water, reactive polymerizable monomers (reactive diluents), and thermally or chemically cross-linking initiators, or only monomers, prepolymers (binders) and thermally or chemically cross-linking initiators.

Usual binders known to a person skilled in the art can be used as UV-curable, thermally and/or chemically cross-linkable binders, wherein both radically polymerizable and also cationically polymerizable binders are suitable. Examples of radical polymerizable binders are in particular acrylate- or methacrylate-functional polymers, prepolymers or oligomers such as polyester(meth)acrylates, polyether(meth)acrylates, amino(meth)acrylates, (meth)acrylcopolymers, polyurethane(meth)acrylates, epoxy resin (meth)acrylates. Preferably the binders contain from 2 to 20 polymerizable olefinic double-bonds per molecule. From 2 to 6 are particularly preferred. Examples of cationically polymerizable binders are in particular epoxy oligomers, such as for example glycerol triglycidyl ether, polyalkylene glycol diglycidyl ether, and epoxy urethane resins. Further examples of binders are melamine resin systems, alkyd resins, silicon resins, cellulose binders and epoxy resins. The binders are used in usual quantities familiar to a person skilled in the art, in particular in quantities of up to 50 wt.-% of the coating composition, preferably up to 15 wt.-%.

The coating systems containing the modified metal effect pigments or metal effect pigment pastes according to the invention can contain UV-curing monomers, which are also called reactive diluents. This is understood to mean molecules that have one or more reactive carbon-carbon multiple bonds. Usual monomers known to a person skilled in the art can be used as reactive diluents. In a preferred embodiment these are acrylate monomers, methacrylate monomers or vinyl monomers. Examples of multi-functional acrylates or methacrylates that can be used in the binder are: tetraethylene glycol diacrylate, triethylene glycol diacrylate, tetraethylene glycol dimethacrylate, triethylene glycol dimethacrylate, polyethylene glycol-400-diacrylate, 2,2′-bis(4-acryloxyethoxyphenyl)propane, ethylene glycol dimethacrylate, diethylene glycol dimethacrylate, 1,6-hexane diol dimethacrylate, 1,6-hexane diol diacrylate, 1,12-dodecane dioldimethacrylate, neopentylglycol dimethacrylate and trimethylolpropane trimethacrylate. Examples of vinyl monomers are vinyl ether etc. The reactive diluents can account for up to 95 wt.-%, preferably from 30 to 80% of the coating composition.

The coating systems containing the modified metal effect pigments or metal effect pigment pastes according to the invention can also contain usual UV photoinitiators known to a person skilled in the art. Examples of radically curing systems are benzophenone and derivatives thereof, benzoin and derivatives thereof, acetophenone and derivatives thereof, anthraquinone, thioxanthone and derivatives thereof, or also organophosphorus compounds. Examples of cationically curing systems are onium salts, in particular diazonium salts, sulphonium salts, or iodonium salts. The photoinitiators are used in usual quantities familiar to a person skilled in the art, in particular in quantities of from 0.5 to 15 wt.-% of the coating composition, preferably from 2-10 wt.-%.

In addition to these compounds, the coating compositions containing the modified metal effect pigments or metal effect pigment pastes according to the invention can contain usual polymerization inhibitors, usual fillers, further pigments, and usual additives, as used in the varnish industry or the printing inks industry. Carbon black, sheet silicates, titanium dioxide, coloured pigments, calcium carbonate and kaolin are also suitable as pigments, and for example silicon dioxide or aluminium silicate are suitable as fillers. Usual additives from the varnishes industry or printing inks industry can be used as additives, in particular dispersants, redispersants, polymerization inhibitors, anti-foaming agents, catalysts, adhesion promoters, levelling agents, thickeners or flatting agents.

The varnishes and paints according to the invention can have different pigment contents depending on application, as known to a person skilled in the art. Particularly preferably the pigment content lies within the range of from 2-45 wt.-%.

The modified metal effect pigments or metal effect pigment pastes can be used in different quantities in thermally or chemically cross-linking varnishes or printing inks, and in UV varnishes or UV printing inks depending on printing process and pigment type. For printing inks or inks, the following table shows, by way of example, preferred wt.-% of pigment per total weight of varnish or ink. Depending on the pigment type, varnishes preferably contain from 2 to 10 wt-% aluminium pigments, 0.1 to 1.5 wt-% Decomet pigments or 3 to 30 wt-% gold bronze pigments.

| Printing Process | Gold bronze | Aluminium | DECOMET ® |
|---|---|---|---|
| Flexographic | 35-40 | 15-20 | 2.5-4.0 |
| Gravure | 30-35 | 10-12 | 2.5-4.0 |
| Screen printing | 35-40 | 15-20 | 4.0-6.0 |
| Offset | 30-45 | 15-25 | 2.5-5.0 |
| Varnishes | 3-30 | 2-10 | 0.1-1.5 |

It is understood that the features mentioned above and those yet to be explained below can be used not only in the stated combinations but also in other combinations or alone, without departing from the scope of the present invention. In particular this applies to the specifically named bifunctional silanes and combinations thereof; metal effect pigments, metal oxide layers, binders, monomers and the respective quantities thereof, different combinations thereof are to be regarded as disclosed according to the invention.

The invention is explained in more detail below, using the following examples.

### EXAMPLES

### Example 1

100 g of SiO₂-coated aluminium pigment Powdal 7400 from Schlenk Metallic Pigments GmbH is suspended in 400 g of isopropanol and heated to 60° C., accompanied by stirring. Subsequently 0.5 g of Dynasylan AMEO (aminopropyltriethoxysilane, APTES), 0.5 g of Dynasylan 6030 (methacryloxypropyltrimethoxysilane, MTMS) (both from Evonik) and 6 g of ammonia (25% in H₂O) are added in quick succession. The mixture is stirred for one hour at 60° C. and then filtered off. The filter cake is subsequently set to a proportion of solids of 60%. The application-technical tests are subsequently carried out with this paste.

### Example 2

100 g of SiO₂-coated aluminium pigment Powdal 7400 from Schlenk Metallic Pigments GmbH is suspended in 400 g of isopropanol and heated to 60° C., accompanied by stirring. Subsequently 0.5 g of Dynasylan GLYMO (epoxysilane), 0.5 g of Dynasylan 6030 (MTMS) (both from Evonik) and 6 g of ammonia (25% in H₂O) are added in quick succession. The mixture is stirred for one hour at 60° C. and then filtered off. The filter cake is subsequently set to a proportion of solids of 60%. The application-technical tests are subsequently carried out with this paste.

### Example 3

100 g of SiO₂-coated aluminium pigment Powdal 2900 from Schlenk Metallic Pigments GmbH is suspended in 400 g of isopropanol and heated to 60° C., accompanied by stirring. Subsequently 0.5 g of Dynasylan 6030 (MTMS), 0.5 g of triethoxysilyl propyl isocyanate (3-isocyanatopropyltriethoxysilane; Aldrich) and 6 g of ammonia (25% in H₂O) are added in quick succession. The mixture is stirred for one hour at 60° C. and then filtered off. The filter cake is subsequently set to a proportion of solids of 60%.

### Comparison Example A

100 g of SiO₂-coated aluminium pigment Powdal 7400 from Schlenk Metallic Pigments GmbH is suspended in 400 g of isopropanol and heated to 60° C., accompanied by stirring. Subsequently 0.5 g of Dynasylan AMEO (APTES) and 6 g of ammonia (25% in H₂O) are added in quick succession. The mixture is stirred for one hour at 60° C. and then filtered off. The filter cake is subsequently set to a proportion of solids of 60%. The application-technical tests are subsequently carried out with this paste.

### Comparison Example B

100 g of SiO₂-coated aluminium pigment Powdal 7400 from Schlenk Metallic Pigments GmbH is suspended in 400 g of isopropanol and heated to 60° C., accompanied by stirring. Subsequently 0.5 g of Dynasylan 6030 (MTMS) and 6 g of ammonia (25% in H₂O) are added in quick succession. The mixture is stirred for one hour at 60° C. and then filtered off. The filter cake is subsequently set to a proportion of solids of 60%. The application-technical tests are subsequently carried out with this paste.

### Comparison Example C

100 g of SiO₂-coated aluminium pigment Powdal 7400 from Schlenk Metallic Pigments GmbH is suspended in 400 g of isopropanol and heated to 60° C., accompanied by stirring. Subsequently 0.5 g of Dynasylan GLYMO (epoxysilane) and 6 g of ammonia (25% in H₂O) are added in quick succession. The mixture is stirred for one hour at 60° C. and then filtered off. The filter cake is subsequently set to a proportion of solids of 60%. The application-technical tests described below are carried out with this paste.

### Condensation Water Test (CWT):

Here a two-layer application to Panels (Herbertsbleche) was carried out. For this, a varnish with a proportion of metal pigment of 6 wt.-% is produced with the respective pastes. The base coat is an aqueous 1K acrylate-PU system. The layer thickness of the applied and cured layer is between 12 and 15 μm. After drying of the panels at 140° C. the panel is left to rest for one day and the clear coat is then applied. The clear coat is a conventional 1K acrylate varnish and is baked at 140° C. The layer thickness is between 17 and 20 μm. The test sheets are exposed to a saturated water vapour atmosphere at a temperature of 40° C. for 240 h. After 10 days' temperature and humidity effect, the optical and technical assessment is carried out after the sheets have been left to rest for 1 h.

The adhesion is then tested by the cross-cut test according to EN ISO 2409. GT0 corresponds to a good result, i.e. very good adhesion. GT5 stands for a clear detachment of the varnish coating (adhesive failure or also cohesive failure), i.e. very poor adhesion.

### PVB System Testing by the Tesa Test:

A printing ink consisting of 25% metal pigment paste (60%), 5% isopropanol and 70% Mowithal B 30 (15% in EtOH) is applied to a coated doctor blade paper with a 24 μm doctor blade and subsequently the doctor blade coating is dried at room temperature for 24 h. Subsequently a Tesa test, which tests the bond strength of the printing ink, is carried out. Here a Tesa adhesive tape is stuck onto the printing ink layer, pressed firmly by being brushed over twice and subsequently pulled off again. It is assessed how much of the printing ink remains on the adhesive film. Here, 5 stands for a very good result and 1 for a poor result. This is carried out according to the standard ISO 105-AO3; 1993, DIN EN 20105-AO3; 1994.

### UV Printing Ink Testing by the Tesa Test:

A printing ink consisting of 25% paste (60% solids content) and 75% Firnis Flexo UV VP/12213 is produced. The further procedure corresponds to the description of PVB system testing by the Tesa test. Subsequently the Tesa test, which tests the bond strength of the printing ink, is carried out. Here, 5 stands for a very good result and 1 for a poor result. The assessment is carried out according to ISO105-AO3; 1993, DIN EN 20105-AO3; 1994.

### UV Printing Ink Testing by the Abrasion Test:

A printing ink consisting of 25% Paste (60% solids content) and 75% Firnis Flexo UV VP/12213 is produced. A doctor-blade coating is then prepared analogously to the Tesa test procedure. The further test sequence is carried out analogously to ISO105-AO3; 1993, DIN EN 20105-AO3; 1994, wherein the assessment is carried out according to the grey scale for assessment of bleeding. Here 5 stands for a very good result and 1 for a poor result.

The following Table 1 gives the results of the examples and the comparison examples according to the invention, of the condensation water test and of the abrasion test.

TABLE 1

| | CWT after | UV printing ink |
|---|---|---|
| | 240 h load | abrasion test |
| Example 1 | GT1 | 5 |
| Comparison | GT1 | 3 |
| example A | | |
| Comparison | GT3 | 5 |
| example B | | |

The following Table 2 gives the results of the examples and the comparison examples according to the invention, of the condensation water test and of the Tesa test.

TABLE 2

| | CWT after | PVB-System | UV printing ink |
|---|---|---|---|
| | 240 h load | Tesa test | Tesa test |
| Example 2 | GT1 | 5 | 5 |
| Comparison | GT3 | 3 | 5 |
| example B | | | |
| Comparison | GT1 | 5 | 2 |
| example C | | | |

The above examples clearly show that the combination of two different bifunctional silanes according to the invention is clearly superior to the individual bifunctional silanes with respect to condensation water resistance, abrasion resistance and adhesion properties.

1. A metal effect pigment, covered with at least one layer of a metal oxide selected from the group consisting of silicon dioxide, aluminium oxide, titanium dioxide, iron oxide, tin oxide, zinc oxide and mixtures thereof, wherein a silane layer which comprises at least two different bifunctional silanes or units derived therefrom is bonded to said layer, characterized in that
the at least two different bifunctional silanes are selected from a combination of
1) a first primary amine-functionalized silane and a second silane selected from the group consisting of (meth)acryl-, vinyl-, cyano-, hydroxyl-, epoxy-, isocyanate-, mercapto-functionalized silane and a secondary amine-functionalized silane, said first and second silane being different
2) a (meth)acryl-functionalized silane and an isocyanate- or epoxy-functionalized silane or
3) an azide-functionalized silane and a (meth)acryl-, vinyl-, cyano-, amine-, hydroxyl-, epoxy-, isocyanate- or mercapto-functionalized silane.

2. A metal effect pigment according to claim 1, containing no other alkyl silane in the same layer, in addition to the at least two different bifunctional silanes and/or having no further layer of one or more organic polymers.

3. The metal effect pigment according to claim 1, wherein the metal effect pigment is selected from the group consisting of aluminium pigments, titanium pigments, zirconium pigments, copper pigments, zinc pigments, gold pigments, silver pigments, silicon pigments, tin pigments, steel pigments, iron pigments, pigments of alloys thereof, and mixtures thereof.

4. The metal effect pigment according to claim 1, wherein the amine-functionalized silane is a silane functionalized with at least one primary or secondary amine group.

5. A process for the production of a metal effect pigment paste, comprising the steps of:
a) suspending a metal effect pigment that is covered with at least one layer of a metal oxide, selected from the group consisting of silicon dioxide, aluminium oxide, titanium dioxide, iron oxide, tin oxide, zinc oxide and mixtures thereof, in an organic solvent or a mixture of organic solvent and water,
b) stirring the suspension accompanied by heating at a temperature in a range of from 20° C. to 80° C.,
c) adding at least two different bifunctional silanes, either simultaneously or successively for the production of a mixture,
d) optional setting of a basic or acid pH by addition of acid or base,
e) stirring the mixture for a period of from 10 minutes to 20 hours at a temperature in a range of from 20° C. to 80° C.,
f) filtering off the mixture to obtain a metal effect pigment paste, and
g) optionally setting solids contents of the metal effect pigment paste in the range of from 50 to 70 wt.-% by addition of organic solvent or water,
wherein the metal effect pigment is selected from the group consisting of aluminium pigments, titanium pigments, zirconium pigments, copper pigments, zinc pigments, gold pigments, silver pigments, silicon pigments, tin pigments, steel pigments, iron pigments and pigments of alloys thereof and wherein the metal effect pigment is covered with at least one layer of a metal oxide, selected from the group consisting of silicon dioxide, aluminium oxide, titanium dioxide, iron oxide, tin oxide, zinc oxide and mixtures thereof and
wherein the at least two different bifunctional silanes are selected from a combination of
1) a first primary amine-functionalized silane and a second silane selected from the group consisting of (meth)acryl-, vinyl-, cyano-, hydroxyl-, epoxy-, isocyanate-, mercapto-functionalized silane and a secondary amine-functionalized silane, said first and second silane being different,
2) a (meth)acryl-functionalized silane and an isocyanate- or epoxy-functionalized silane or
3) an azide-functionalized silane and a (meth)acryl-, vinyl-, cyano-, amine-, hydroxyl-, epoxy-, isocyanate- or mercapto-functionalized silane.

6. The process according to claim 5, wherein the stirring of the suspension in step b) is accompanied by heating at a temperature in the range of from 25° C. to 60° C.

7. The process according to claim 5, wherein in step d) a pH is set in the range of from 8 to 11 by addition of aqueous basic solution.

8. The process according to claim 7, wherein the aqueous basic solution is an aqueous solution of ammonia, triethylamine or ethylene diamine.

9. The process according to claim 5, wherein the stirring of the mixture in step e) is effected over a period of from 30 minutes to 3 hours.

10. A coating composition comprised of a metal effect pigment according to claim 1.

11. The coating composition of claim 10, which is a varnish, paint, printing ink, nail varnish, ink, surface coating or plastic.

12. A coating composition comprised of the metal effect pigment obtained by a process according to claim 5.

13. The coating composition of claim 12, which is a varnish, paint, printing ink, nail varnish, ink, surface coating or plastics.

14. The metal effect pigment according to claim 4 wherein the at least one primary or secondary amine functionalized silane is selected from:
3-aminopropyltriethoxysilane, 3-aminopropyltrimethoxysilane, 4-aminobutyltriethoxysilane, 3-aminopropyltris(methoxyethoxyethoxy)silane, 11-aminoundecyltriethoxysilane, 3-aminopropyl silanetriol, 3-aminopropylmethyldiethoxysilane, 3-aminopropyldiisopropylethoxysilane, 3-aminopropyldimethylethoxysilane, N-aminoethyl-aminopropyltrimethoxysilane, N-aminoethyl-3-aminopropyltriethoxysilane, N-aminohexyl-2-aminomethyltriethoxysilane, N-aminohexyl-aminomethyltrimethoxysilane, N-aminoethyl-11-aminoundecyltrimethoxysilane, (aminomethylaminomethyl)phenethyltrimethoxysilane, N-aminoethyl-3-aminopropyl silanetriol, N-aminoethyl-3-aminopropylmethyldimethoxysilane, N-aminoethyl-aminoisobutylmethyldimethoxysilane, (amino ethylamino)isobutyldimethylmethoxysilane, (trimethoxysilylpropyl)diethylene triamine, N-methyl-3-aminopropyltrimethoxysilane, N-ethylaminoisobutyltrimethoxysilane, N-(n-butyl)-3-aminopropyltrimethoxysilane, N-(n-butyl)-3-aminopropyltriethoxysilane, N-(n-propyl)-3-aminopropyltriethoxysilane, N-(n-propyl)-3-aminopropyltrimethoxysilane, N-phenyl-3-aminopropyltrimethoxysilane, N-allyl-3-aminopropyltrimetoxysilane, N-ethylaminoisobutylmethyldiethoxysilane and N-methyl-3-aminopropylmethyldimethoxysilane,
the (meth)acryl-functionalized silane is selected from the group consisting of:
3-methacryloxypropyltrimethoxysilane, 3-methacryloxypropyltriethoxysilane, 2-methacryloxyethyltrimethoxysilane, 2-methacryloxyethyl-triethoxysilane, 3-methacryloxypropyltris(methoxyethoxy)silane, 3-meth-acryloxypropyltris(butoxyethoxy)silane, 3-methacryloxypropyl-tris(propoxy)silane, 3-methacryloxypropyltris(butoxy)silane, 3-acryl-oxypropyltrimethoxysilane, 2-acryloxyethyltrimethoxysilane, 3-acryl-oxypropyltrimethoxysilane, 2-acryloxy-ethyltriethoxysilane, 3-acryl-oxypropyltris(methoxy-ethoxy)silane, 3-acryloxypropyl-tris(butoxyethoxy)silane, 3-acryloxypropyl-tris(propoxy)silane and 3-acryloxypropyltris(butoxy)silane, the vinyl-functionalized silane is selected from the group consisting of: vinyltrimethoxysilane, vinyltriethoxysilane, vinylethyldichlorosilane, vinylmethyldiacetoxysilane, vinylmethyldichlorosilane, vinyl-methyldiethoxysilane, vinyltriacetoxysilane and vinyl trichlorosilane,
the cyano-functionalized silane is selected from the group consisting of: 3-cyanopropyltriethoxysilane, 3-cyano-propyltrimethoxysilane and 2-cyanoethyltrimethoxysilane,
the isocyanate-functionalized silane is selected from the group consisting of: 3-isocyanatopropyltriethoxysilane and 3-isocyanatopropyltrimethoxysilane, the mercapto-functionalized silane is selected from the group consisting of: 3-mercaptopropyltriethoxysilane, 3-octanoylthio-1-propyltriethoxysilane and 3-mercaptopropyltrimethoxysilane,
the epoxy-functionalized silane is selected from the group consisting of: 3-glycidyloxypropyltrimethoxysilane, beta-(3,4-epoxycyclohexyl)ethyltrimethoxysilane and 1,2-epoxy-4(ethyltriethoxysilyl)cyclohexane, and/or
the azide-functionalized silane is selected from the group consisting of: 6-azidosulphonylhexyltriethoxysilane and (azidomethyl)phenethyltrimethoxysilane.

15. The process according to claim 5 wherein the stirring of the suspension in step (b) is conducted at a temperature of approximately 60° C.

16. The process according to claim 7, wherein in step (d), the pH is set to a range of 8.5 to 9.6 by addition of aqueous basic solution.

17. The process according to claim 5 wherein the stirring of the mixture in step (e) is effected over a period of about 1 hour at temperature ranging from 25° C. to 60° C.

18. The process according to claim 17 wherein the stirring of the mixture is effected at approximately 60° C.
